(19) United States
(12) Patent Application Publication
(10) Pub. No.: US 2018/0054352 A1
(43) Pub. Date: Feb. 22, 2018

(54) MODULAR INFORMATION TECHNOLOGY TOOLS WITH AUTOMATED ACTIVATION AND DEACTIVATION

(71) Applicant: International Business Machines Corporation, Armonk, NY (US)

(72) Inventors: Thomas E. Chefalas, Somers, NY (US); Florian D. Graf, Zurich (CH); Andrzej Kochut, Mount Kisco, NY (US); Birgit M. Pfitzmann, Wettswil (CH); Suraj Subramanian, Lafayette, LA (US); Mahesh Viswanathan, Yorktown Heights, NY (US)

(21) Appl. No.: 15/241,276

(22) Filed: Aug. 19, 2016

(51) Int. Cl. H04L 12/24; G06F 17/30; G06F 3/0482; G06F 9/445

(52) U.S. Cl. CPC H04L 41/082; G06F 8/61; G06F 3/0482; G06F 17/30312

(57) ABSTRACT

A service catalog may be stored on a storage device and represent systems management tools with types, managed component types the systems management tools can manage, and dependencies associated with the systems management tools. A portal comprises a user interface receiving a request for a systems management tool from the service catalog. A configuration management database stores registered state of the systems management tools and the managed components managed by the systems management tools. An orchestration component is capable of coupling a computer-executable plugin to activate, deactivate, and run the systems management tool on a managed component.

### FIELD

The present application relates generally to computers and computer applications, and more particularly to a computer framework providing modular computer-implemented tools for managing computer components.

### BACKGROUND

A Managed-Infrastructure-as-a-Service (MIaaS) cloud provides full-service virtual machines. The service may, for example, include operating system (OS) patching and support for security and compliance of the OS. Many customers or users may expect this of a cloud because information technology (IT) management causes larger costs than software and hardware.

In a known managed cloud system, all management services are installed at provisioning time on all provisioned servers. No choice is provided to selectively provision services and the existing architecture for the managed cloud system would not make it easily amenable for choosing services to install.

### BRIEF SUMMARY

A method and system in one embodiment provides a framework that modularly manages IT services on a computing environment providing on-demand network access to a shared pool of configurable computing resources. The method may include installing a central server associated with the systems management tool and coupling the central server with a configuration management database storing registered state of the systems management tools and managed components managed by the systems management tools. The method may also include installing a plugin associated with the systems management tool and operable to activate, deactivate, and run the systems management tool on a managed component, and coupling the plugin with an orchestration component.

A system that modularly manages IT services on a computing environment providing on-demand network access to a shared pool of configurable computing resources, in one aspect, may include a service catalog stored on a storage device and representing systems management tools with types, managed component types the systems management tools can manage. The service catalog may also store dependencies associated with the systems management tools. A portal includes a user interface receiving a request for a systems management tool from the service catalog. A configuration management database stores registered state of the systems management tools and the managed components managed by the systems management tools. An orchestration component is operable to couple a computer-executable plugin to activate, deactivate, and run the systems management tool on a managed component. The portal and the cloud orchestration component executes on at least one hardware processor.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating components of a system in one embodiment of the present disclosure.

FIG. 2 is a diagram showing a state of system components responsive to registering a management service in one embodiment of the present disclosure.

FIG. 3 is a diagram showing a state of system components responsive to provisioning a managed component in one embodiment of the present disclosure.

FIG. 4 is a flow diagram illustrating a method of activating a management service for a managed component in one embodiment of the present disclosure.

FIG. 5 is a flow diagram illustrating a method in one embodiment of the present disclosure.

FIG. 6 illustrates a schematic of an example computer or processing system that may implement a system that provides for modular framework in one embodiment of the present disclosure.

### DETAILED DESCRIPTION

A system, method, and techniques are disclosed for modular IT management, for example, on a cloud environment. In one embodiment, the modular IT management is provided with automated activation and deactivation of management services capability. A user or a customer, for example, may have a special preference of how IT management is performed, for example, with special vendor affinities, or because of affinity to internal reporting. Even within one customer, it may be useful to manage some servers or software differently, for example, short-lived development and/or test servers with little management or no virus checking for an operation system, for example, AIX.

It is also useful if the modular management services can be activated at any time, not only during provisioning of a managed system. For example, a customer may start with monitoring service and later, when the system is built-up, add a backup service. Moreover, flexibility in selecting management tools enables a marketplace of management services, thus enabling competition and finally the best services. In one aspect, modular IT management services may need special care because they all manage the same managed components (e.g., servers, software). For example, this type of management should be done consistently and safely, for example, by providing consistent state of each managed component in a configuration management database (CMDB), respecting a joint identity and access management for access to the managed components, avoiding conflicts on the same managed component, respecting dependencies (for example, event management may depend on a monitoring service) and even fulfilling these dependencies automatically, and providing a joint dashboard for the user (for example, with a view per managed component). Briefly, CMDB is a repository or data warehouse that stores data relating to IT installations. In IT systems, systems management tools comprise computer-implemented components that can provide centralized management of IT assets, for example, monitor and manage IT systems and address and solve IT problems.

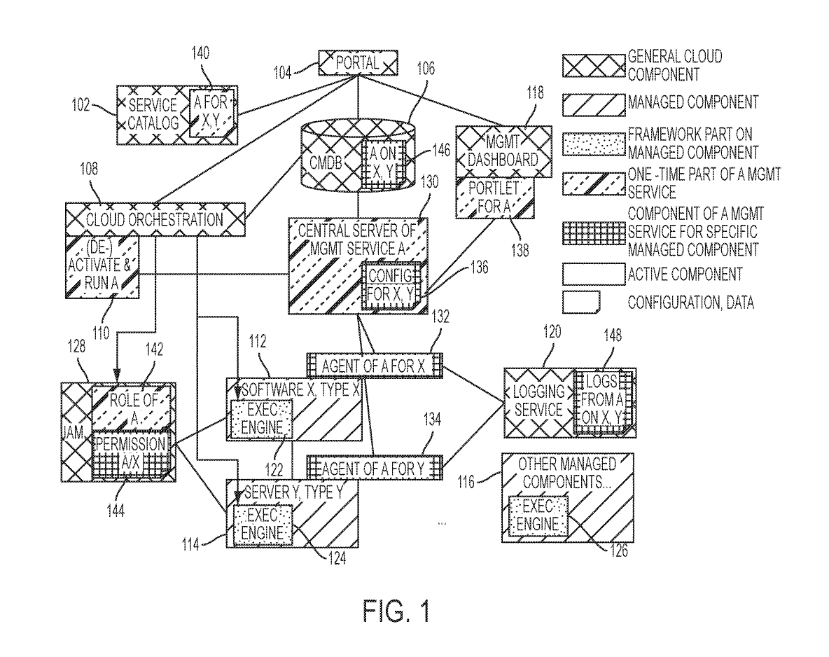

In one embodiment a solution for modular IT management services is provided that includes a software framework. Modular IT management services may be provided as modules that can provide services for selected managed components. FIG. 1 is a diagram illustrating components of a system in one embodiment of the present disclosure. The system may include a service catalog 102 for documenting (or storing information) related to the systems management tools, the systems management tools' capabilities and dependencies. The service catalog 102 may be stored data, for example, as part of a database or extensible markup language (XML) file or another file type. In one aspect, information in the service catalog 102 are displayed through a portal, for example, shown at 104. The service catalog 102 represents management services with types, the managed component types the management services can manage, and dependencies. In one embodiment, the service catalog data for a management service A contains at least: The name of the service; a category of the service from a predefined data model, e.g., “patching” or “monitoring”; types of managed components it can manage, e.g., “Windows OS”, “DB2”, “Firewall”, e.g., from a predefined data model; the rights needed for managing each such component, e.g., “DB2Admin”, e.g., from a predefined data model. The system may also include a portal 104 (for example, a web portal or other interface) via which the management services in the service catalog 102 can be ordered, for example, in relation to managed components. A CMDB 106 documents or stores the current deployment of systems management tools on managed components and results of the tools (such as patch level of the components managed by a patching tool, inventory discovered by a discovery tool, and/or others). Cloud orchestration 108 with a plugin framework activates, deactivates, and/or runs plugins 110 from each systems management tool on specific managed components. For each management service (e.g., monitoring, backup), the cloud orchestration 108 coordinates a separate module. New management services can be added to this framework. The cloud orchestration 108, in one embodiment is implemented as a server, and has the capabilities to execute the activation and deactivation of the management services in a structured way, obeying the dependencies between them, handling potential errors or outages, and provides status updates to the portal 104 and CMDB 106. For example, a plugin 110 may activate, deactivate and run a systems management service for a target managed component 112, 114, 116. For example, “Activate Monitoring” installs a monitoring agent depending on the OS platform (e.g., Windows™, Linux™, or AIX™) or other selected managed component. An execution engine (e.g., 122) is part of the framework and enables the scripted or automated deployment of the configurations and agents. Considering managed components that are deployed as full landscapes (for example, high-available cluster configurations), deployment of a management system may occur in an automated way on multiple managed servers. A management dashboard 118 is a user interface that allows the individual systems management tools be used in a common context. The management dashboard 118 provides an operational view of the managed components. For example, each deployed manage component has attributes which are important for operating and/or monitoring the managed component. A portlet (e.g., 138) may be provided for each management service and can display, for example, system utilization, last full backup, applied security policies, and/or other information, depending on the type of the management service to which the portlet belongs. The management dashboard 118 may be a part of the portal 104. A joint identity and access management (IAM) 128 for the managed components and management services, and a logging service 120 may be provided. IAM may store a role of an agent and permission parameters of the agent on a managed component type. For example, an agent belonging to a monitoring system may need to run as a user MON, which needs to be in an Administrator group. During the activation of the agent on a managed component, IAM can be contacted, where a role and permissions can be found on what degree of authority is given to the deployed agent. The logging service logs changes made during systems managements of a managed component. In one embodiment, the logging service is centralized, and the centralized logging component stores all the activities being performed on a managed component for audit and troubleshooting activities. For example, information such as the exact version of each agent that is installed, configurations of the managed component that were changed as part of that installation, and an additional local user that was created for that agent to run may be logged. In the event of warnings or a failure during activation of a management service, those are also logged. The logging service logs may be used for audit, for example. A central server 130 of a management service may also contact the logging service 120. An endpoint execution engine 122, 124, 126 accesses managed components. During provisioning of a managed component 112, 114, 116, the cloud orchestration 108 installs an execution engine 122, 124, 126 that enables future manipulation of the manage component 112, 114, 116. The execution engine 122, 124, 126 enables cloud orchestration to install agents and manipulate the configuration of the managed components. Examples of execution engines are Chef and Secure Shell (SSH). In one embodiment, among such agents are the agents of the management services to be installed subsequently. For example, Chef or SSH are the execution engines on the managed servers, which will handle the subsequent installation of the agents of management services (monitoring agent, for example). Briefly, cloud orchestration involves automatically arranging, coordinating and managing computer systems, for example, including error and outage handling, applications such as distributed applications and services.

Systems management services in this framework may include one or more central servers (for example, there may be a central server per site or point of deployment (PoD of the cloud) 130. These central servers are specific to the management service. For example, for a monitoring service, the central servers may be a relay server in each site and a monitoring console in a central location for the cloud. The same may apply to patching and backup example management services. Computer-implemented agents 132, 134 of the management service for managed components 112, 114 may be installed and configured during activation, for example, by the cloud orchestration 108 (e.g., by the plugin 110). A management service may be agent-less for one or more managed components 116. If it is agent-less for a server component 114 (i.e., a physical or virtual operating system), the central server 130 can connect to the managed component either from the outside (e.g., for a security management service to run port scans) or to run commands via the execution engine (e.g., SSH, Chef). If it is agent-less for a software component 112, for example a database or a web server on top of an operating system 114, it may reuse its agent 134 for the operating system to also manage the software. For instance, a backup management system typically has separate agents 132 for databases (an example of software 112), but no separate agents 132 for web servers (another example of software 112). This is so that the databases are backed up in a specific way retaining database consistency, while the web servers and their content are simply backed as part of the file system of the underlying operating system (server 114). As part of activation, configurations 136 in the central server 130 for the managed components may be also configured. For instance, for a backup activation, the retention policy for the data or the backup schedule may be configured in the central backup server 130 rather than the backup agents 134, 132. A portlet 138 is a user interface for the management dashboard 118. The portlet 138 provides an interface that displays operational parameters of that specific management service into the portal, for example, monitoring information, last full backup, and/or others. The management dashboard 118 may also show summarized results from all management services (as obtained via the individual portlets) for a managed component. For this, the management dashboard may require in its Application Programming Interface (API) specification that the portlets 138 provide results in a standard format per service management type (e.g., “last patched” for all patching services, so that it can be shown in the main server list). A plugin 110 to the Cloud Orchestration 108 activates, deactivates, and/or runs a systems management tool on a managed component. Briefly, a plugin refers to a computer-implemented component, for example, software component, that adds a specific functionality or feature to an application or another component via a well-defined API of the other component, here the Cloud Orchestration 108. Management dashboard 118 in one embodiment may provide operational and management view, for example, including technical details for operating an infrastructure (e.g., for technical personnel of a cloud provider). Portal 104 provides a customer view (e.g., for cloud customers). In one aspect, the management dashboard 118 and the portal 104 may be separate components, offering separate views. In another embodiment, these two components can be integrated into one single web server, e.g., with different access rights for different roles (such as cloud customer and cloud personnel). Portal 104 provides a consistent view for the modular management service activation and deactivation. Thus, besides showing the catalog as described above, it also enables a customer to select management services from the catalog and to enable them for certain managed components, e.g., for servers 114 or software 112 that the customer has ordered from the cloud. There may also be a joint ordering process, e.g., to put a new server into a shopping cart and adding a backup service, a monitoring service, and a virus checking service for it in the same shopping cart, referring to the not-yet-existing server by its ordering ID. If a management service is activated (or deactivated or run) later for an already existing managed component 112 or 114, reference to this can be made by a server name, a service ID or the like, which is consistently assigned in the CMDB and shown in the portal.

Components shown in FIG. 1 execute on one or more hardware processors. In one embodiment, the following components comprise cloud components: service catalog 102, portal 104, CMDB 108, cloud orchestration 106, identity and access management 128 and logging service 120. The components 112 (e.g., software of a type), 114 (e.g., server of a type) and 116 (e.g., another managed component) are examples of managed components. In one embodiment, the execution engines 122, 124, 126 are framework parts or components installed on managed components. In one embodiment, a plugin 110 for activating, deactivating and running an agent, a central server 130, specification of role of an agent 142, and portlet 138 are one-time parts of a management service. One-time means that they exist in a fixed number, largely independent of the number of managed components (servers and software) being managed by this management service. There may in fact be a slow growth of the number, for example, with each new cloud site one may need a new relay server for a monitoring service (all counting as part of 136), or with every thousand managed servers 114, one may need an additional backup server in a backup server cluster 136. In one embodiment, configuration 144 specifying permission parameters of an agent on a managed component, configuration 136 for the management service on a particular managed component (such as 112, 114) residing on the central server 130 of that management service, configuration 146 specifying agents on specific managed components in the CMDB 106, agents 132, 134 and logs 148 are components of a management service for a specific managed component. Management services are also referred to as management systems or systems management tools.

Processing that may be performed in the framework may include registration of a new systems management tool; provisioning of managed components with access for the endpoint execution engine; and activating, deactivating, and/or running a systems management service on a managed component. For example, methods may include automatic registration of a new systems management tool, and execution of activation, deactivation, and run requests. A method may also include resolving dependencies and conflicts between systems management tools on managed components.

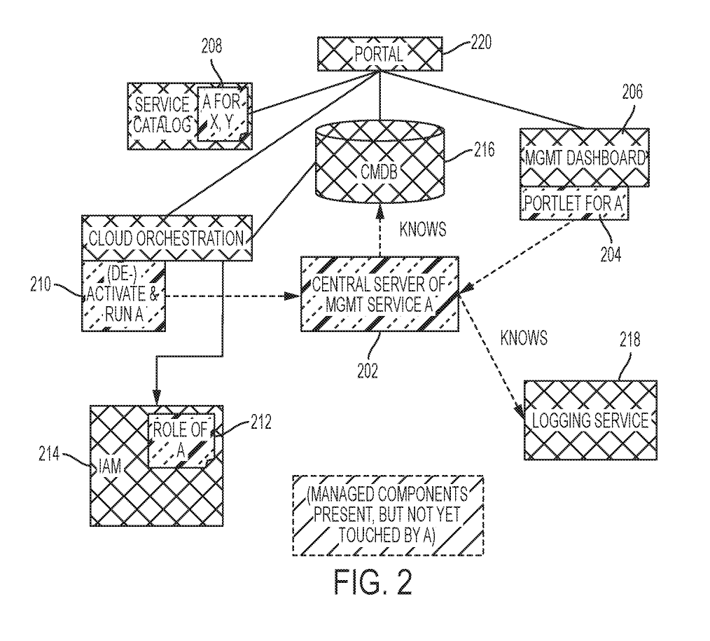

FIG. 2 is a diagram showing a state of system components (for example, shown in FIG. 1) responsive to registering a management service in one embodiment of the present disclosure. For the sake of explanation, an example management service is referred to as “A” or management service A. A portal 220 provides a user interface that allows a user access to provisioning a managed component; it may also enable the automated registering of a new management service like A in this example; otherwise registering a new management service is separate depolyment task, e.g., triggered in the cloud development system. Enabling the registering through the portal enables a marketplace of management services without intervention by the central cloud operator. In one embodiment, a management service may be packaged as three active components which include a central server, a portlet, and an activate/deactivate and run component, and two types of metadata, a service catalog entry and the IAM role of A. A central server 202 may be provided as a silent installer for an OS offered for example in the cloud or like computing environment. In another aspect, the central server 202 may be provided as a fully runnable image. The central server functions as a back-end server for the specific management service. For example, the backups or the monitoring results may be stored here. The central server 202 is installed. In one embodiment, the portlet 204 is provided in a standard format for the management dashboard 206, and is installed. The service catalog data for management service A 208 contains at least: The name of the service; the category of A from a predefined data model, e.g., “patching” or “monitoring”; types of managed components it can manage, e.g., “Windows OS”, “DB2 database”, or “Firewall” from a predefined data model; the rights needed for managing each such component, e.g., “DB2Admin” for managing DB2 databases, from the predefined data model. In one embodiment, the service catalog and the CMDB follows a predefined data model, for example, so that the data can be stored in the database in a structured manner. CMDBs are commercially available, e.g., the IBM Tivoli Configuration and Change Management Database. If the standard data model of a selected CMDB product does not contain all the service catalog data described above, it can be extended by them. The data model may be defined as a machine processable structure.

Activate, deactivate and run component 210 (shown as (De-)active & run A) contains code for:

Activating management service A for a specific managed component (e.g., x 112 and y 114 shown in FIG. 1) of a type listed in the service catalog data for A 208; deactivating that management service A on specific managed component; and running that management service A (e.g., to actually patch x or perform another service on x). Such code exists once for each type (e.g., X, Y) of managed components that management service A can manage according to the service catalog data 208. For instance, if A is a monitoring service available for DB2 databases as X and Linux OS as Y, then the activate, deactivate and run component 210 for A contains one code piece for activating monitoring on DB2 databases, one code piece for deactivating monitoring on DB2 databases, one code piece for activating monitoring on Windows OS, etc.

The role of management service A 212, as described in the catalog data 208, is installed in the IAM system 214. There is no concrete access yet. For instance, each management service may require a set of technical users and permissions to run on the managed components. IAM system 214 may also function to provide appropriate access to the operations team.

In one embodiment, addressing is established automatically during the registration by a standard scheme. For example, the central server of the management service 202 learns the addresses of CMDB 216 and logging service 218; the portlet 204 and the activate, deactivate and run component 210 learn the address of the central server 202. The managed components are present in the system but not yet touched at the registration phase of a management service.

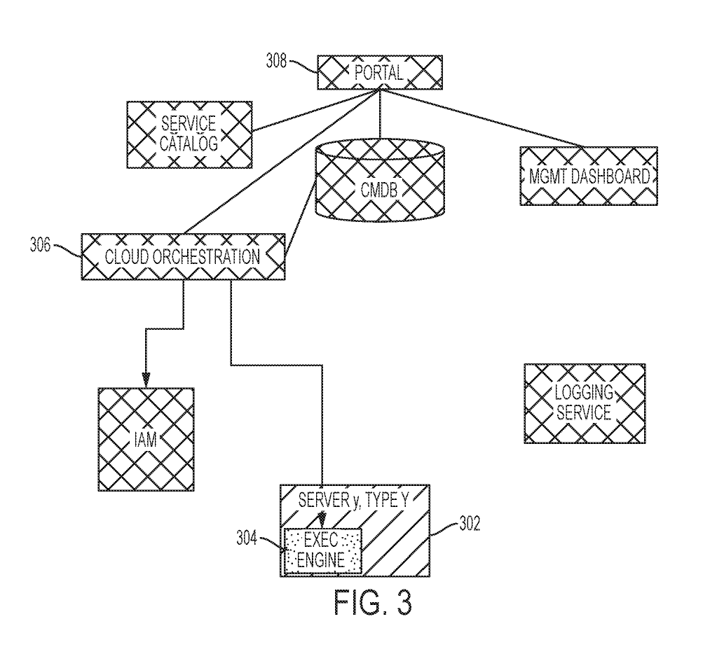

FIG. 3 is a diagram showing a state of system components (for example, shown in FIG. 1) responsive to provisioning a managed component in one embodiment of the present disclosure. FIG. 3 shows components provided in place before an activation of a management service for a managed component can occur. Provisioning refers to the initial build of a component, such as a server, a database, web server, a firewall, or a load balancer, for example, out of the cloud. This managed component is requested from the service catalog (as in 102) and registered in the CMDB (as in 106 and 216), and subsequently the cloud orchestration 306 instantiates this managed system. For example, if a (virtual) server y of Type Y (say Linux) is requested (with additional parameters such as the exact operating system version and the required CPU and memory resources), the cloud orchestration instantiates such a server on the hardware and the virtualization system. This instantiation also includes the setup of the execution engine for further cloud operations on this managed component (e.g., SSH may be already part of the provisioning image; else it can be installed now). Once the provisioning has taken place, selected management services on top of the virtual machine (VM) can be activated via the Portal.

A managed component 302 is provisioned with an execution engine 304 on it that allows future manipulation by the cloud orchestration 306. For example, the execution engine 304 is installed on the managed component 302. In one embodiment, the execution engine 304 can be an SSH product and the public key of the cloud orchestration. SSH is a tool that provides remote console access not only to users but can also be leveraged programmatically. For instance, each time a component is to be executed on the management service the cloud orchestration connects via SSH to the managed server and starts the automation. The methodology of the present disclosure, however, is not limited to SSH. Other tools may be implemented as execution engine. In one embodiment, the execution engine 304 can also be an agent of a configuration management system such as IBM Tivoli Endpoint Manager from International Machines Corporation, New York, CHEF, or PUPPET. In that case, in one embodiment of the present disclosure, the configuration management system is considered a part of cloud orchestration. For example, once the managed component has been provisioned with the execution engine, the execution engine (e.g., SSH) acts as a hook that can start the automation. In other words, it enables remote command execution on the managed system. The commands to be executed are sent by the cloud orchestration, one by one or as scripts (also called recipes in the case of CHEF).

The portal 308 provides a user interface that allows a user access to a catalog of management services and to request activation, deactivation and run for the managed components that the user owns or where the user has been granted management rights by the owner.

Whether higher-level or nested managed components, for example, the software x 112 on server y 124, need their own execution engine may depend on the type of software and on access management. For example, to be able to manipulate a database, the original execution engine may be sufficient, but it may need additional database administrator (DBadmin) rights or permission levels.

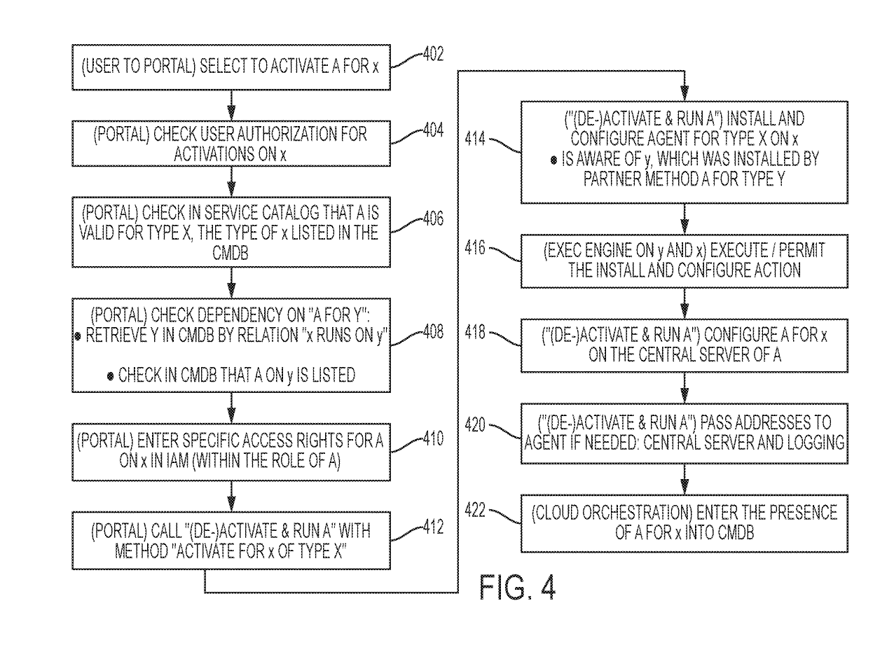

FIG. 4 is a flow diagram illustrating a method of activating a management service for a managed component in one embodiment of the present disclosure. At 402, a portal (e.g., FIG. 1 at 104), via a user interface, allows a user to select to activate a management service A for a managed component x. For example, the portal may display a user interface for searching the service catalog and selecting a service from the service catalog, and present the selected service or a list of services, for example, management service A and the rights the management service A has (e.g., administrator privilege). The portal may also present configuration parameters of the requested management service. For example, the version of the to-be-installed agent, or the used backup server, the backup frequency, and the backup retention time. The portal finds these parameters and the permitted values (e.g., retention time 4 weeks, 3 months, or 2 years) in the Service catalog entry for A (e.g., FIG. 1 at 140).

At 404, the portal checks user authorization for activations on the managed component x. For example, the user's authorization levels may be stored in an IAM system (FIG. 1 at 128), which the portal may look up. The user, for example, may be the owner of the managed component x, in which case the user is determined to have the requisite authorization level. In another example, the user may belong to the IT management team of the organization to which component x belongs and also have the requisite authorization level.

At 406, the portal checks in the service catalog whether the management service A is valid for type X of the managed component x. The type of component x is listed in the CMDB. For instance, a certain backup service may be available for the Linux servers but not AIX servers, or vice versa.

In one embodiment, the modular services framework of the present disclosure is capable of handling dependencies between the management services. In this case, at 408, the portal checks for any dependency that the selected management service has on any other managed component types, for example, on which it is running. For example, IBM Tivoli Monitoring (ITM) for database DB2 may require ITM for the server (operating system) on which this DB2 database is running. In another example, monitoring a cluster may involve monitoring each of the cluster nodes. Which relations of the given CMDB (as in 106) constitute such dependencies is configured in the portal (as in 104) during the initial deployment of the portal for this environment, e.g., a specific cloud. For example, for checking dependency on management service A for a component y of type Y, the portal may be configured to know “runs on” is a dependency relation, query the CMDB for all components y with relation “x runs on y” (finding only one operating system component y in our example), and check in the CMDB that management service A on managed component y is listed. In one aspect, these code parts may be put into the cloud orchestration component (e.g., FIG. 1 at 108) for use by the portal 104. The decision whether this code is added to the portal code or the cloud orchestration code may be based on the programmability capabilities of the portal framework.

In one aspect, a dependency between “A on Type X” and “A on Type Y” may be used for automatic installation or for example, to prompt the user for installation, if management service A had not been present (installed) on managed component y yet. If this aspect is chosen, then in the above example, if ITM is not yet installed on the underlying operating system y when ITM for a DB2 database x is requested, then automatically first the ITM operating system agent is installed on y and then the ITM DB2 agent on database x.

Dependencies may also exist between different management services, e.g., a monitoring service A may integrate with a specific event management system or reporting system B. Then the portal may give a warning if one of these systems is activated for a component x while the other is not, or it may automatically activate both. In one aspect, these dependencies can be generalized to types. For example, a type (such as “event management”) may prescribe detailed application programming interfaces (APIs) for management services of another type (such as “monitoring service”) that want to interact with it (e.g., to send specific monitoring results such as exceeding a utilization schedule to the event management service for handling as a potential incident). These APIs would go beyond the minimum ones needed to participate in the framework. In one aspect, one might make such types with specified dependencies subtypes of the most general types. In the above example, one might call them “monitoring-enabled event management services” (a subtype of “event management services”) and “event-management-capable monitoring services” (a subtype of “monitoring services”). Then only vendors who offer these APIs can register their management services as the corresponding subtypes.

At 410, the portal enters specific access rights for the selected management service (service A) on the managed component (x) on IAM, for example, within the role of A. For instance, if a service needs a local account DBAdmin on the operating system (as specified in the role of A), then this account has to be established on x now. Or a setting in a directory service (such as LDAP) may need to be made to enable A to run on x.

At 412, the portal calls the activate, deactivate and run component (e.g., FIG. 1 at 110) with method that activates the selected management service A on the managed component x of type X. For example, the portal invokes the activate, deactivate and run component to execute the activation method provided by the activate, deactivate and run component.

Based on the invocation 412, at 414, a computer-implemented agent of management service A for type X of the selected managed component x is installed on the managed component x and configured. For example, the component (activate, deactivate and run component) shown in FIG. 1 at 110 may install and configure the agent. If a dependency of x on another component y was detected at 408 and an agent of A is already present on y (as in FIG. 1 at 134), the activate, deactivate and run component is aware of this agent and appropriately adds the agent of x (as in FIG. 1 at 132) to it. For example, if ITM for a DB2 database is to be installed (as 132), and the presence of ITM for the underlying operating system (134) was validated in 408, the activate, deactivate and run component installs the ITM-for-DB2 agent as a correct add-on to the ITM-for-OS agent. For the actual actions on the managed component x, the activate, deactivate and run component invokes the execution engine (e.g., FIG. 1 at 122 and FIG. 3 at 304) already present on managed component x from the provisioning of component x. This is possible because the activate, deactivate and run component (e.g., FIG. 1 at 110 and FIG. 2 at 210) is a plugin to the cloud orchestration (e.g., FIG. 1 at 108) and therefore has the ability to interact with the execution engines of the cloud orchestration.

At 416, an execution engine on the selected managed component x permits and executes the installation of the agent and configuration action for configuring the agent. If another managed component, for example, managed component y also needs an agent installed and configured (e.g., because of the discovered dependency between components x and y), an execution engine on managed component y may also execute and permit an installation and configuration of a corresponding agent on that managed component y. The decisions for this and the actual commands and scripts were all sent to the execution engine by the activate, deactivate and run component in the invocation within 414.

At 418, the activate, deactivate and run component configures the selected management service A for the managed component x on the central server of A (e.g., FIG. 1 at 130, 136). For example, installing a management service, e.g., a storage manager for backup data may also require an account on a back-end server which provides the space/storage for the backup. The central server functions as this back-end server.

At 420, the activate, deactivate and run component transmits addresses of the central server and logging service to the installed agent (e.g., FIG. 1 at 132) if needed, for example, for logging and communication. For example, at this step the installed agent is connected to the back-end server. A specific example is to configure a TSM (Tivoli Storage Manager) agent to use server-tsm.domain.com for backups.

At 422, the cloud orchestration component enters the presence of the selected management service (A) for the managed component (x) into CMDB. The CMDB carries the configuration information of the environment. In this way, information such as which service has which state (activated or deactivated) on each of the managed components can be known and, for example, be shown in the portal. Another use of this information was seen in the dependency analysis 408. The results of all the processing steps 402 to 422 from the calls described may synchronous or asynchronous, i.e., the invoking component may actively wait for the response, or be triggered later by the invoked component with a call-back, or query the invoked component at certain intervals for a result.

Deactivation works similarly to the activation process described above. In one embodiment, for migration and in case of another administration occurring on the server for a managed component, it is useful to have a deactivation function that tolerates installations that are not exactly as the activation process produces them.

In one embodiment, the run function of the activate, deactivate and run component is an abstract method (in the sense of object-oriented programming) that management services can implement with more specific functions, typically their core function, for example, “patch” for a patching service, “check” for a security health checking service, or “create a backup” for a backup service. In one embodiment, the service catalog (e.g., FIG. 1 at 102) specifies whether a management system implements this method. For specific types of management services, the framework in one embodiment may also offer, for example, in its data model, more specific (but still abstract) methods that management services of this type need to implement: for example, “patch” may be a required method for all patching services and also implement “run”, while for backup services, “backup” and “restore” may be required, where “backup” also implements “run”. For example, such required method may exist as running on a specific managed component (“run on x”) and running on all managed components (“run on all”), or all of a specific types or fulfilling certain constraints (e.g., to patch all Linux RedHat operating systems of version 6.6).

Conflicts may exist for a type of managed components. For example, two management services of the same type may be in conflict such as for patching, active configuration management, and/or security health checking and remediation, for instance, since tools in the two management services may write into the same parts of the managed components.

Responsive to detecting a conflict, the framework of the present disclosure in one embodiment provides an alert signal, for instance, a message to provide a warning to a user. This is done by the portal 104 when the user requests the activation of an additional management service for a managed component 112, 114, or 116. The portal bases its in information on general conflict information in the service catalog 102, and on information about management services already activated for the same managed component in the CMDB 106. Another alert signal that the framework may provide is a message that advises two OS-level monitoring tools may be superfluous and waste resources (although they are not actually conflicting), for example, in the event the user selects to run more than one OS-level monitoring tool. Another example of a conflict detected by the framework may be use of the same port for communication, for example, and checking the port use on the managed component by other software or applications. An appropriate alert or warning signal may be issued to the user, for example, via the portal.

In one embodiment, capabilities of individual systems management types can be added to the service catalog, for example, to its predefined data model. For instance, the following capabilities may be defined: what retention periods a backup system allows; what level of security in the data transfers or storage are implemented; what patching policies a patching tool allows and how fast security-critical patches will be evaluated. Other capabilities may be defined.

In one embodiment, based on the defined capabilities, a policy-based selection can be performed from a set of systems management tools. For example, a selection criterion may ask for “a backup system with encrypted storage and at least 5 years retention capability.”

As described above, a system and method of the present disclosure in one embodiment provides a framework to modularly manage IT services on a cloud, for example, throughout the entire lifecycle of a management service and of its use on specific managed components. For instance, the framework allows for activating a management service, wherein the service recipient can choose or request a service from a service catalog. A portal is provided in the framework that allows for checking the requested management service on compatibilities with existing deployed management services on the same managed component, pulling other dependent management services, requesting the deployment of the management service at the cloud orchestration and updating the CMDB. The framework further allows for running a management service, where the service recipient executes and consumes the ordered service. The content of this phase is specific to the type of service. The framework also allows for deactivating a management service on a specific managed component, where the service recipient can request to stop the service. In this case, the management service is being shut-down on that managed component, and the configuration on IT infrastructure (in particular the central server of this management service) may be removed and CMDB entries updated.

A system and method of the present disclosure allows for orchestrating modular IT management services on a cloud. A service catalog represents management services with types, the managed component types they can manage, and dependencies. A portal allows for ordering management services from the service catalog. The portal may also contain a management dashboard. A CMDB allows for registering the state of management services and the managed components managed by them. A cloud orchestration component is provided with a framework for plugins that activate, deactivate, and run a systems management tool on a managed component. In one embodiment, a common IAM and logging service are used by the systems management tools. In one embodiment, the cloud orchestration in provisioning of a managed component installs an execution engine enabling future manipulation of the managed component. The systems management tools may include one or more central servers and agents that are installed and configured in the activate step. The framework also allows for detecting, alerting and resolving dependencies and conflicts between systems management tools on managed components.

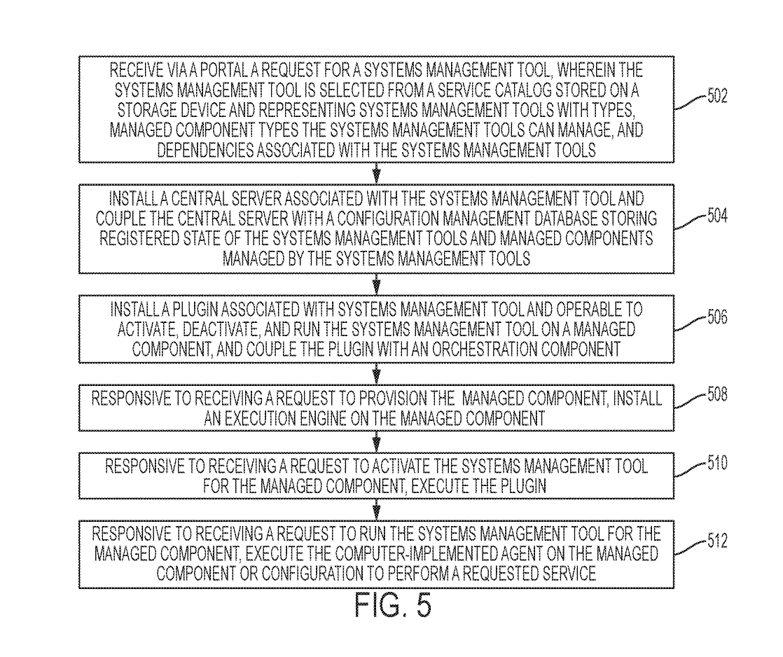

FIG. 5 is a flow diagram illustrating a method in one embodiment of the present disclosure. The method, for example, provides for a framework that modularly manages IT services on a computing environment providing on-demand network access to a shared pool of configurable computing resources, for example, on a cloud computing environment. At 502, a request is received via a portal for a systems management tool, referred to also in this disclosure as management service. For example, the systems management tool is selected from a service catalog stored on a storage device. The service catalog represents systems management tools with types, managed component types the systems management tools can manage and dependencies associated with the systems management tools.

At 504, the method may include installing a central server associated with the systems management tool and coupling the central server with a configuration management database. The configuration management database stores registered state of the systems management tools and managed components managed by the systems management tools.

At 506, the method may include installing a plugin associated with the systems management tool and coupling the plugin with an orchestration component. The plugin is operable to activate, deactivate, and run the systems management tool on a managed component.

At 508, responsive to receiving a request to provision the managed component, the method may include installing an execution engine on the managed component.

At 510, responsive to receiving a request to activate the systems management tool for the managed component, the method may include executing the plugin. The plugin, for example, installs the computer-implemented agent on the managed component via the execution engine, updates configuration in the central server for the managed component, and enters the presence of the systems management tool for the managed component in the configuration management database. In one embodiment, the plugin may configure the systems management tool on the managed component without installing or using an agent. In one embodiment, the plugin may set configuration data on the central server to activate the systems management tool for the managed component.

At 512, responsive to receiving a request to run the systems management tool for the managed component, the method may include executing the computer-implemented agent on the managed component. In one embodiment, for a managed component that does not have an agent, configuration data or direct remote command execution via the execution engine may be used to implement the service.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

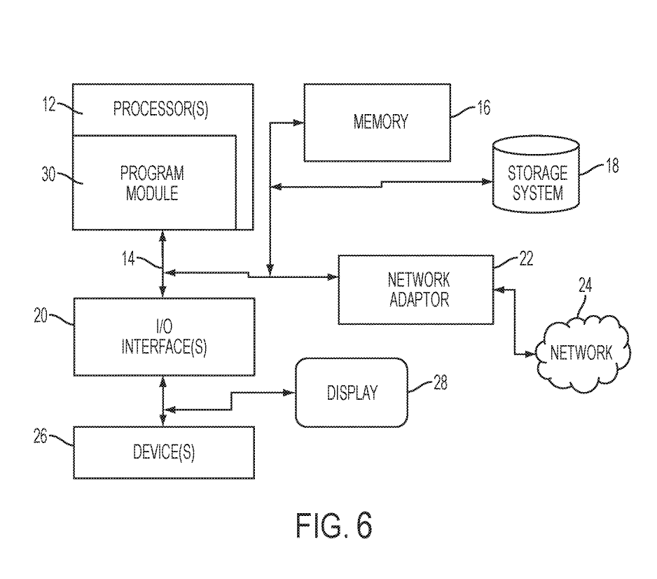

FIG. 6 illustrates a schematic of an example computer or processing system that may implement a system that provides for modular framework in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A system that modularly manages information technology (IT) services on a computing environment providing on-demand network access to a shared pool of configurable computing resources, comprising:
a service catalog stored on a storage device and representing systems management tools with types, managed component types the systems management tools can manage;
a portal comprising a user interface receiving a request for activating a systems management tool from the service catalog for a managed component;
a configuration management database storing registered state of the systems management tools and the managed components managed by the systems management tools; and
an orchestration component operable to couple a computer-executable plugin to activate, deactivate, and run the systems management tool on the managed component,
the portal and the cloud orchestration component executing on at least one hardware processor.

2. The system of claim 1, wherein the portal comprises a dashboard displaying management results.

3. The system of claim 1, wherein the systems management tool communicates with a common identity and access management, and logging service to provide access and logging services.

4. The system of claim 1, wherein the systems management tool comprises at least a central server and the plugin, wherein responsive to the portal receiving a request to register the systems management tool, the plugin is coupled to the orchestration component and the central server is coupled to the configuration management database.

5. The system of claim 4, wherein the systems management tool further comprises a portlet associated with a dashboard that presents management results, and the portlet is coupled to the portal responsive to receiving the request to register the systems management tool.

6. The system of claim 1, further comprising an execution engine, the orchestration component installing the execution engine on the managed component responsive to receiving a request to provision the managed component.

7. The system of claim 4, wherein responsive to the portal receiving a request to activate the systems management tool for the managed component, the orchestration component executes the plugin, the plugin configuring the managed component via an execution engine provisioned on the managed component for managing by the systems management tool.

8. The system of claim 4, wherein the systems management tool further comprises a computer-implemented agent, wherein responsive to the portal receiving a request to activate the systems management tool for the managed component, the orchestration component executes the plugin, the plugin installing the computer-implemented agent on the managed component via an execution engine provisioned on the managed component, and updating configuration in the central server for the managed component.

9. The system of claim 1, wherein the service catalog further stores dependencies associated with the systems management tools, wherein the orchestration component is further operable to detect and resolve dependencies and conflicts occurring between the systems management tools managing the managed component.

10. The system of claim 1, wherein the service catalog comprises at least names of the systems management tools, types of managed components the systems management tools can manage, and access rights needed for managing the managed components.

11. A method of modularly managing IT services on a computing environment providing on-demand network access to a shared pool of configurable computing resources, comprising:
installing a central server associated with a systems management tool and coupling the central server with a configuration management database storing registered state of systems management tools and managed components managed by the systems management tools; and
installing a plugin associated with the systems management tool and operable to activate, deactivate, and run the systems management tool on a managed component, and coupling the plugin with an orchestration component.

12. The method of claim 11, further comprising:
responsive to receiving a request to provision the managed component, installing an execution engine on the managed component.

13. The method of claim 12, further comprising:
responsive to receiving a request to activate the systems management tool for the managed component, executing the plugin, the plugin installing the computer-implemented agent on the managed component via the execution engine, updating configuration in the central server for the managed component, and entering presence of the systems management tool for the managed component in the configuration management database.

14. The method of claim 12, further comprising:
responsive to receiving a request to activate the systems management tool for the managed component, executing the plugin, the plugin updating configuration in the central server for the managed component and entering presence of the systems management tool for the managed component in the configuration management database.

15. The method of claim 11, further comprising:
responsive to receiving a request to run the systems management tool for the managed component, executing the computer-implemented agent on the managed component.

16. A computer readable storage medium storing a program of instructions executable by a machine to perform a method of modularly managing IT services on a computing environment providing on-demand network access to a shared pool of configurable computing resources, the method comprising:
installing a central server associated with a systems management tool and coupling the central server with a configuration management database storing registered state of systems management tools and managed components managed by the systems management tools; and
installing a plugin associated with the systems management tool and operable to activate, deactivate, and run the systems management tool on a managed component, and coupling the plugin with an orchestration component.

17. The computer readable storage medium of claim 16, further comprising:
responsive to receiving a request to provision the managed component, installing an execution engine on the managed component.

18. The computer readable storage medium of claim 17, further comprising:
responsive to receiving a request to activate the systems management tool for the managed component, executing the plugin, the plugin installing the computer-implemented agent on the managed component via the execution engine, updating configuration in the central server for the managed component, and entering presence of the systems management tool for the managed component in the configuration management database.

19. The computer readable storage medium of claim 17, further comprising:
responsive to receiving a request to activate the systems management tool for the managed component, executing the plugin, the plugin updating configuration in the central server for the managed component and entering presence of the systems management tool for the managed component in the configuration management database.

20. The computer readable storage medium of claim 16, further comprising:
responsive to receiving a request to run the systems management tool for the managed component, executing the computer-implemented agent on the managed component.
